(19) United States
(12) Patent Application Publication
(10) Pub. No.: US 2026/0010301 A1
(43) Pub. Date: Jan. 8, 2026

(54) MEMORY SYSTEM WITH MULTIPLE INPUT/OUTPUT INTERFACES

(71) Applicant: Micron Technology, Inc., Boise, ID (US)

(72) Inventors: Nicholas T. Heath, Pittsboro, NC (US); Gaurav Sinha, Unterschleißheim, Bayern (DE)

(21) Appl. No.: 19/243,542

(22) Filed: Jun. 19, 2025

Related U.S. Application Data
(60) Provisional application No. 63/667,933, filed on Jul. 5, 2024.

(51) Int. Cl. G06F 3/06

(52) U.S. Cl. CPC G06F 3/0625; G06F 3/0659; G06F 3/0673

(57) ABSTRACT

Methods, systems, and devices for a memory system with multiple input/output (I/O) interfaces are described. The memory system may include a first flash translation layer (FTL) module coupled with a first I/O interface and configured to operate according to a first set of rules. And the memory system may include a second FTL module coupled with a second I/O interface and configured to operate according to a second set of rules.

### CROSS REFERENCE

The present Application for Patent claims priority to U.S. Patent Application No. 63/667,933 by Heath et al., entitled “MEMORY SYSTEM WITH MULTIPLE INPUT/OUTPUT INTERFACES,” filed Jul. 5, 2024, which is assigned to the assignee hereof, and which is expressly incorporated by reference in its entirety herein.

### TECHNICAL FIELD

The following relates to one or more systems for memory, a memory system with multiple input/output (I/O) interfaces.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a memory system with multiple I/O interfaces in accordance with examples as disclosed herein.

FIG. 2 shows an example of a system that supports a memory system with multiple I/O interfaces in accordance with examples as disclosed herein.

FIG. 3 shows an example of a process flow that supports a memory system with multiple I/O interfaces in accordance with examples as disclosed herein.

FIG. 4 shows a block diagram of a memory system with multiple I/O interfaces in accordance with examples as disclosed herein.

FIG. 5 shows a flowchart illustrating a method or methods that support a memory system with multiple I/O interfaces in accordance with examples as disclosed herein.

### DETAILED DESCRIPTION

A memory system may be deployed in an environment in which the memory system services (e.g., stores information for) multiple devices, which may be referred to as client devices. For example, a memory system may be deployed in a vehicle (e.g., a car) that includes various processors for different tasks as well as various sensors for providing environmental information. The memory system may route information received from the client devices (and information for transfer to the client devices) through a flash translation layer (FTL) module that processes the information for storage in (and retrieval from) memory media of the memory system. The FTL module may be configured with and operate according to various operating rules, such as communication rules (e.g., rules that define how information is transmitted and/or received over input/output (I/O) interfaces coupled with the client devices) and storage rules (e.g., rules that define how information is stored in the memory media). But the operating rules of the FTL may not be tailored to the individual workloads of the client devices, which may result in communication and storage inefficiencies and other challenges.

According to the techniques described herein, a memory system may improve performance by including multiple FTL modules that are configured with different operating rules. For example, the memory system may include a first FTL module that is configured with, and operates according to, a first set of operating rules and may include a second FTL module that is configured with, and operates according to, a second set of operating rules. The first set of operating rules may be tailored to the workload of the client devices coupled with the first FTL module via a first set of I/O interfaces, whereas the second set of operating rules may be tailored to the workload of the client devices coupled with the second FTL module via a second set of I/O interfaces.

In addition to applicability in memory systems as described herein, techniques for multiple FTL modules may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, multiple FTL modules may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving data transfer between devices and enabling increased communications between devices, among other benefits.

Features of the disclosure are illustrated and described in the context of systems, devices, and circuits. Features of the disclosure are further illustrated and described in the context of a process flow, a block diagram, and a flowchart.

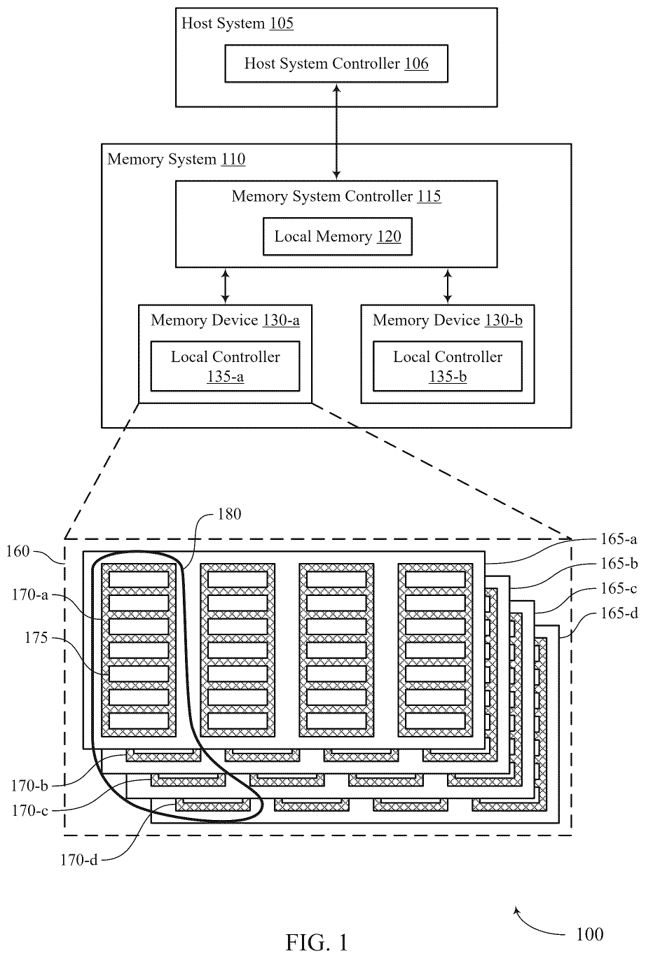

FIG. 1 shows an example of a system 100 that supports a memory system 110 with multiple I/O interfaces in accordance with examples as disclosed herein. The system 100 includes a host system 105 coupled with the memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

Although shown coupled with the host system 105, which may be considered a client device, in some cases, the memory system 110 may be coupled with multiple client devices. For example, if the memory system 110 is included in a vehicle such as a car, the memory system 110 may be coupled with one or more processors (e.g., processors for providing in-vehicle entertainment, processors for providing driver assistance, processors for providing location services)) as well as one or more sensors (e.g., cameras, radar devices, sonar devices, light detection and ranging (LiDAR) devices). The client devices may have different workloads that the memory system 110 is expected to handle. For example, the processors may transmit a mix of read commands and write commands that are associated with both random access and sequential access of the memory devices 130. In contrast, the sensors may transmit predominately write commands that are primarily associated with sequential access of the memory devices 130.

To process client device data (e.g., for storage or for transmission to the client devices), the memory system 110 may route the data through an FTL module that manages operation of the memory devices 130. For example, the FTL module may perform logical-to-physical (L2P) address mapping in which the FTL module translates logical addresses, used by the host system 105, to physical addresses, used by the memory devices 130. Additionally, or alternatively, the FTL module may control memory maintenance procedures such as wear-leveling, garbage collection, and bad block management.

The FTL module may be configured with a set of operating rules designed to accommodate the different workloads of the client devices. But the set of operating rules may not be tailored to the individual workloads of the client devices, which may negatively impact the performance of the memory system 110. For example, the set of operating rules may increase write amplification, which in turn may reduce the amount of memory available for client device data and lower the endurance of the memory system 110. Additionally, or alternatively, the set of operating rules may increase memory maintenance operations (e.g., garbage collection operations), which may increase latency and lower the endurance of the memory system 110, as well as increase the size of the local memory 120, which may increase manufacturing costs.

According to the techniques described herein, the memory system 110 may improve performance by using multiple FTL modules configured with client device-specific operating rules. For example, the memory system 110 may include a first FTL module that is configured with a first set of operating rules that is tailored to the workloads of a first set of client devices, and may include a second FTL module that is configured with a second set of operating rules that is tailored to the workloads of a second set of client devices. Further, the first FTL module may be coupled with one or more I/O interfaces that are configured to communicate in accordance with a first set of communication rules tailored to the workloads of the first set of client devices, and the second FTL module may be coupled with one or more I/O interfaces that are configured to communicate in accordance with a second set of communication rules tailored to the workloads of the second set of client devices.

The system 100 may include any quantity of non-transitory computer readable media that support a memory system with multiple I/O interfaces. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

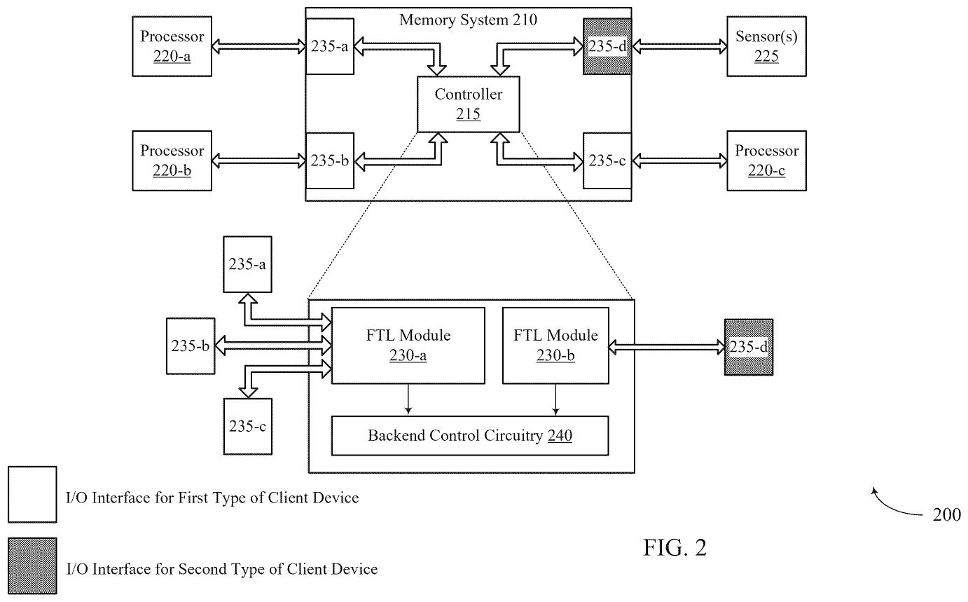

FIG. 2 shows an example of a system 200 that supports a memory system 210 with multiple I/O interfaces in accordance with examples as disclosed herein. The system 200 may be an example of a system 100 as described with reference to FIG. 1, or aspects thereof. For example, the system 200 may include a memory system 210, which may be an example of a memory system 110 as described with reference to FIG. 1. The memory system 110 may be configured to store data for one or more client devices. In some examples, the system 200 may be included in a vehicle such as a car (e.g., a self-driving car).

The system 200 may include different types of client devices such as processors 220 (e.g., processor 220-a, processor 220-b, processor 220-c) and sensor(s) 225. The processors 220 may be configured to perform various processing tasks such as in-vehicle entertainment, driver assistance, and location services. The sensor(s) 225 may be configured to capture environmental data for the system 200 and may include devices such as cameras, radar devices, sonar devices, and LiDAR devices, among others. To efficiently accommodate the different workloads of the different types of client devices, the memory system 210 may include multiple FTL modules 230 as well as multiple I/O interfaces.

Although described with reference to processors and sensors, the client devices are not limited to these examples and may be any type of client devices. In some examples, the client devices may be external to the packaging of the memory system 210.

The memory system 210 may include a controller 215, which may be an example of a memory system controller 115 as described with reference to FIG. 1. The controller 215 may be configured to control the flow of data between the memory media of the memory system 210 (e.g., one or more non-volatile memory devices) and the client devices. For example, the controller 215 may receive commands (e.g., routed through the I/O interfaces) from the client devices and may control the operations of the memory system 210 to service those commands. The commands received from the client devices may include read commands (e.g., commands that instruct the memory system 210 to provide data from the memory media to a client device) and write commands (e.g., commands that instruct the memory system 210 to store data from a client device in the memory media).

Information (e.g., commands, data) may be routed between the memory system 210 and the client devices via one or more I/O interfaces 235, which may also be referred to as ports or other suitable terminology. The I/O interfaces 235 may couple the memory system 210 with the client devices and may be configured to communicate commands and data between the client devices and the memory system 210. For example, an I/O interface 235 may be configured to receive commands and data from a client device and transmit the commands and data to the controller 215. Additionally, the I/O interface 235 may be configured to receive data from the controller 215 and transmit the data to the client device that requested the data. Thus, the I/O interfaces 235 may be bi-directional (e.g., capable of communicating in both directions relative to the memory system 210). The I/O interfaces 235 may include hardware components such as I/O pins, receivers, modulation/demodulation circuitry, encoding/decoding circuitry, and the like, for communicating and processing commands and data.

The I/O interfaces 235 may be coupled with one or more respective client devices and may be configured to communicate according to communication rules that are tailored to the workloads of the coupled client devices. For example, the I/O interface 235-a, the I/O interface 235-b, and the I/O interface 235-c may be coupled with processor 220-a, processor 220-b, and 220-c, respectively, and may each be configured to communicate according to a first set of communication rules that define (e.g., control) how information (e.g., commands, data) is to be communicated between the processors 220 and the memory system 210.

The first set of communication rules may be tailored to the workloads of the processors 220. For instance, the first set of communication rules may define a first size of data (or a first range of sizes) that is permitted to be communicated (e.g., per command) between the processors 220 and the memory system 210. The first range of sizes may be relatively large to accommodate the wide variety of tasks performed by the processors 220. In some examples, the first set of communication rules may permit communication of data in a sequential manner as well as in a random (e.g., nonsequential) manner. Communication of data in a sequential manner may refer to the communication of data that is associated with (e.g., to be written to) a range of physical addresses that are sequentially indexed (e.g., physical addresses 1, 2, 3, 4), whereas communication of data in a random manner may refer to the communication of data that is associated with (e.g., to be written to) a range of physical addresses that are non-sequentially indexed (e.g., physical addresses 3, 14, 1, 28). In some examples, the I/O interfaces 235-a, 235-b, and 235-c may be referred to as general purpose I/O interfaces.

The I/O interface 235-d may be coupled with the sensor(s) 225 and may be configured to communicate according to a second set of communication rules that define (e.g., control) how information (e.g., commands, data) is to be communicated between the sensor(s) 225 and the memory system 210. The second set of communication rules may be tailored to the workloads of the sensor(s) 225. For instance, the second set of communication rules may define a second size of data (or a second range of sizes) that is permitted to be communicated (e.g., per command) between the processors 220 and the memory system 210. The second range of sizes may be narrow relative to the first range of sizes to streamline processing and storage of the data. In some examples, the second set of communication rules may permit communication of data in exclusively a sequential manner and may prohibit communication of data in a random manner. In some examples, the I/O interface 235-d may be referred to as a sensor I/O interface.

To further accommodate the different workloads of the client devices, the controller 215 may include multiple FTL modules 230 for processing commands and preparing data for storage in the memory media of the memory system 210. For example, the controller 215 may include FTL module 230-a and FTL module 230-b. The FTL module 230-a may be configured with, and operate in accordance with, a first set of operating rules, whereas the FTL module 230-b may be configured with, and operate in accordance with, a second set of operating rules. In some examples, an FTL module 230 may be a controller that, among other functions, performs address translation in which logical addresses are mapped to physical addresses of the memory media. So, the FTL module may be the combination of hardware, firmware, and tables that translates host information (e.g., namespace and logical address) into the physical address space (e.g., die, plane, block, page) and vice versa. The translations may be in both directions (e.g., for both read operations and write operations).

The first set of operating rules may include the first set of communication rules and a first set of storage rules. So, the FTL module 230-a, which may be coupled with the processors 220 through the I/O interfaces 235-a, 235-b, and 235-c, may communicate with the I/O interfaces 235-a, 235-b, and 235-c in accordance with the first set of communication rules supported by the I/O interfaces 235-a, 235-b, and 235-c. The first set of storage rules may define a third size (or third range of sizes) of data that is permitted to be stored in the memory media (e.g., on a per access operation basis). In some examples, the third size is equal to the first size. In some examples, the third range of sizes is equal to the first range of sizes. In some examples, the first set of storage rules may permit storage of data in a sequential manner as well as in a random (e.g., nonsequential) manner. Storage of data in a sequential manner may refer to the storage of data in memory locations with sequentially indexed physical addresses, whereas storage of data in a random manner may refer to the storage of data in memory locations with non-sequentially indexed physical addresses.

The FTL module 230-b may be configured with, and operate in accordance with, a second set of operating rules that includes the second set of communication rules and a second set of storage rules. So, the FTL module 230-b, which may be coupled with the sensor(s) 225 through the I/O interface 235-d, may communicate with the I/O interface 235-d in accordance with the second set of communication rules supported by the I/O interface 235-d. The second set of storage rules may define a fourth size (or fourth range of sizes) of data that is permitted to be stored in the memory media (e.g., on a per access operation basis). In some examples, the fourth size is equal to the second size. In some examples, the fourth range of sizes is equal to the second range of sizes. In some examples, the second set of storage rules may permit storage of data in exclusively a sequential manner and may prohibit storage of data in a random manner.

In some examples, the FTL modules 230 may be configured to implement different processing architectures, such as a Zoned Namespace (ZNS) architecture or a Flexible Data Placement (FDP) architecture. In an ZNS architecture, the client device with data to store in the memory system 210 may control the memory location where the data is stored. For example, applications on a client device may write data into separate zones of the memory system 210. In an FDP architecture, the client device with data to store in the memory system 210 may provide hints on where the memory system 210 should write the data.

The FTL modules 230 may be coupled with a common backend control circuitry, which may act as an intermediary between the FTL modules 230 and the non-volatile memory devices of the memory system 210. For example, FTL module 230-a and FTL module 230-b may each be coupled with backend control circuitry 240, which may interface and communicate with the non-volatile memory devices on behalf of, or in response to control signaling from, the FTL modules 230. In some cases, data associated with the memory devices (e.g., data for writing to the memory devices, data read from the memory devices) may be routed through the backend control circuitry 240.

Although described with reference to a particular configuration of processors 220 and sensor(s) 225, the designs and techniques described herein may be implemented in other configurations. For example, the system 200 includes two processors 220 and two sensor(s) 225, in which case the memory system 210 may include two general purpose I/O interfaces and two sensor I/O interfaces. As another example, the system 200 may include one processor 220 and three sensor(s) 225, in which case the memory system 210 may include one general purpose I/O interface and three sensor I/O interfaces. In general, if the system 200 includes x client devices of a first type and y client devices of a second type, the memory system 210 may include x I/O interfaces with a first set of rules specific to the workloads of the first type of client device and may include y I/O interfaces with a second set of rules specific to the workloads of the second type of client device. In such scenarios, the x I/O interfaces may be coupled with a first FTL module configured with the first set of rules and the y I/O interfaces may be coupled with a second FTL module configured with the second set of rules. Alternatively, an I/O interface may be coupled with multiple client devices of the same type.

Although described with reference to two FTL modules, the designs and techniques described herein may be implemented for other quantities of FTL modules. For example, if the system 200 includes n different types of client devices, the memory system 210 may include n FTL modules each configured with a respective set of rules. To illustrate, if the system 200 includes x client devices of a first type, y client devices of a second type, and z client devices of a third type, the memory system 210 may include a first FTL module coupled (e.g., through x or fewer I/O interfaces) with the x client devices of the first type, a second FTL module coupled (through y or fewer I/O interfaces) with the y client devices of the second type, and a third FTL module coupled (through z or fewer I/O interfaces) with the z client devices of the third type.

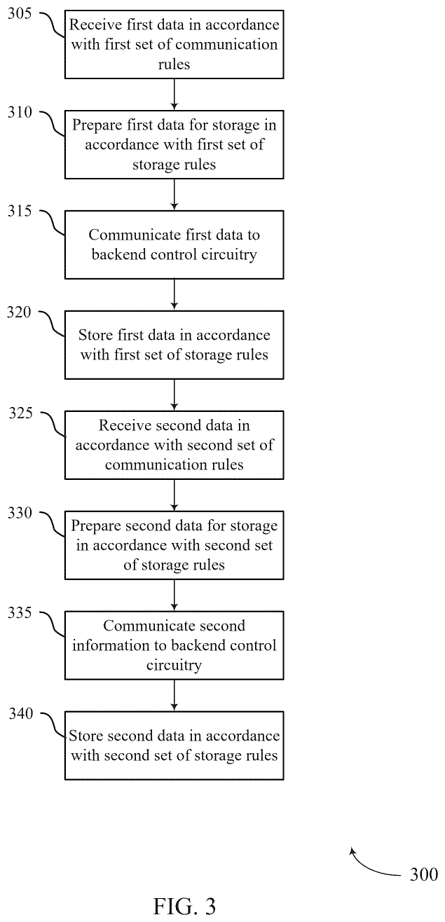

FIG. 3 shows an example of a process flow 300 that supports a memory system with multiple I/O interfaces in accordance with examples as disclosed herein. The process flow 300 may be implemented by a memory system such as the memory system 210. In some examples, the memory system may be included in a vehicle. The memory system may be coupled with at least one client device of a first type (referred to as client device A) and at least one client device of a second type (referred to as a client device B). Accordingly, the memory system may include at least one I/O interface (referred to a I/O interface A) configured with a first set of communication rules and a second I/O interface (referred to as I/O interface B) configured with a second set of communication rules.

At 305, a first FTL module of the memory system may receive the first data. The first data may be from client device A and may be received from I/O interface A in accordance with the first set of communication rules. For example, the first data may be received in a sequential manner or in a random manner. Additionally, or alternatively, the first data may be received in a size that falls within a first range of sizes defined by the first set of communication rules. The first range of sizes may represent the amount of data that is permitted to be associated with an access command (e.g., a write command). The first FTL module may also receive control information (e.g., an access command such as a write command) associated with the first data.

At 310, the first FTL module may prepare the first data for storage in accordance with a first set of storage rules. For example, the first FTL module may prepare the first data for storage in a sequential manner or in a random manner. Additionally, or alternatively, the first FTL module may prepare (e.g., packetize) the first data so that it has a second size that falls within a second range of sizes defined by the first set of storage rules. The second range of sizes may represent the amount of data that is permitted to be concurrently written to the memory media.

At 315, the first FTL module may communicate the first data (along with corresponding control information) to backend control circuitry. At 320, the backend control circuitry may store the first data in accordance with the first set of storage rules.

At 325, a second FTL module of the memory system may receive second data. The second data may be from client device B and may be received from I/O interface B in accordance with the second set of communication rules. For example, the second data may be received in a sequential manner. Additionally, or alternatively, the second data may be received in a size that falls within a third range of sizes defined by the second set of communication rules. The third range of sizes may represent the amount of data that is permitted to be associated with an access command (e.g., a write command). The second FTL module may also receive control information (e.g., an access command such as a write command) associated with the second data.

At 330, the second FTL module may prepare the second data for storage in accordance with a second set of storage rules. For example, the second FTL module may prepare the second data for storage in a sequential manner by mapping the second data to physical addresses that are sequential addresses. Additionally, or alternatively, the second FTL module may prepare (e.g., packetize) the second data so that it has a second size that falls within a fourth range of sizes defined by the second set of storage rules. The fourth range of sizes may represent the amount of data that is permitted to be concurrently written to the memory media, the amount of data that is permitted to be written to the memory media in a sequential manner, or both.

At 335, the second FTL module may communicate the second data (along with corresponding control information) to backend control circuitry. At 340, the backend control circuitry may store the second data in accordance with the second set of storage rules.

Thus, different FTL modules may be used to process data from different client devices, which may improve the efficiency of the memory system. Aspects of the process flow 300 may be implemented by one or more controllers, among other components. Additionally, or alternatively, aspects of the process flow 300 may be implemented as instructions stored in one or more memories (e.g., firmware stored in one or more memories coupled with the memory system 110, firmware stored in one or more memories coupled with the memory system 210). For example, the instructions, if executed by one or more controllers (e.g., the memory system controller 115, a local controller 135, the controller 215), may cause the one or more controllers (or a device or a system) to perform the operations of the process flow 300.

Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

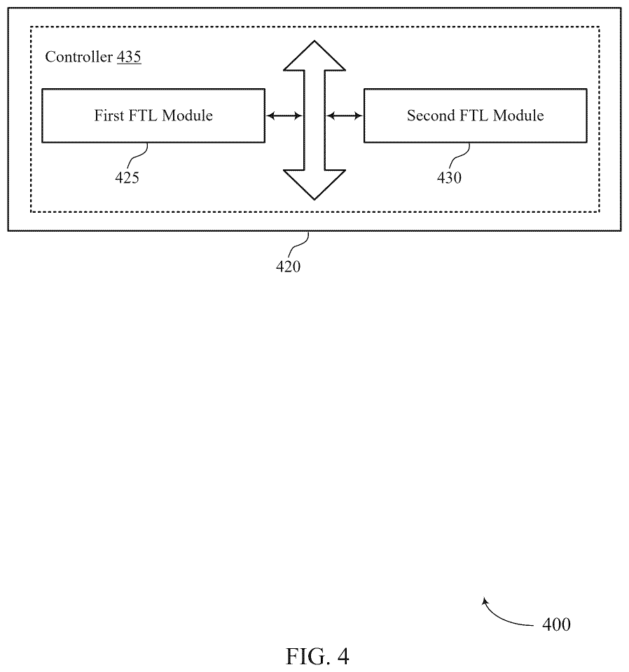

FIG. 4 shows a block diagram 400 of a memory system 420 that supports multiple I/O interfaces in accordance with examples as disclosed herein. The memory system 420 may be an example of aspects of a memory system as described with reference to FIGS. 1 through 3. The memory system 420, or various components thereof, may be an example of means for performing various aspects that support multiple I/O interfaces as described herein. For example, the memory system 420 may include a first FTL module 425 a second FTL module 430, or any combination thereof. Each of these components, or components of subcomponents thereof (e.g., one or more processors, one or more memories), may communicate, directly or indirectly, with one another (e.g., via one or more buses). In some examples, the first FTL module 425 and the second FTL module 430 are included in or part of a controller 435 of the memory system 420.

The first FTL module 425 may be configured as or otherwise support a means for receiving, at a first flash translation layer (FTL) module coupled with a first I/O interface, first data from the first I/O interface in accordance with a first set of communication rules for communicating over the I/O interface. In some examples, the first FTL module 425 may be configured as or otherwise support a means for preparing, at the first FTL module, the first data for storage in the non-volatile memory device in accordance with a first set of storage rules for storing data in the non-volatile memory device. The second FTL module 430 may be configured as or otherwise support a means for receiving, a second FTL module coupled with a second I/O interface, second data from the second I/O interface in accordance with a second set of communication rules for communicating over the second I/O interface. In some examples, the second FTL module 430 may be configured as or otherwise support a means for preparing, by the second FTL module, the second data for storage in the non-volatile memory device in accordance with a second set of storage rules for storing data in the non-volatile memory device.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

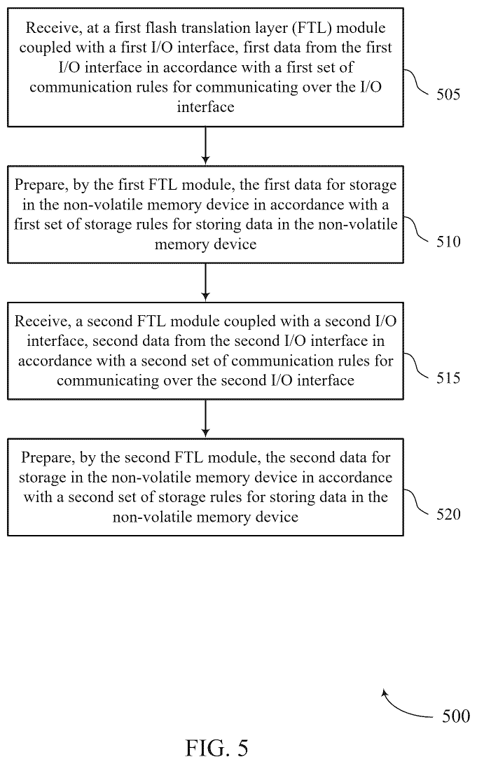

FIG. 5 shows a flowchart illustrating a method 500 that supports a memory system with multiple I/O interfaces in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at a first flash translation layer (FTL) module coupled with a first I/O interface, first data from the first I/O interface in accordance with a first set of communication rules for communicating over the I/O interface. In some examples, aspects of the operations of 505 may be performed by a first FTL module 425 as described with reference to FIG. 4.

At 510, the method may include preparing, by the first FTL module, the first data for storage in the non-volatile memory device in accordance with a first set of storage rules for storing data in the non-volatile memory device. In some examples, aspects of the operations of 510 may be performed by a first FTL module 425 as described with reference to FIG. 4.

At 515, the method may include receiving, at a second FTL module coupled with a second I/O interface, second data from the second I/O interface in accordance with a second set of communication rules for communicating over the second I/O interface. In some examples, aspects of the operations of 515 may be performed by a second FTL module 430 as described with reference to FIG. 4.

At 520, the method may include preparing, by the second FTL module, the second data for storage in the non-volatile memory device in accordance with a second set of storage rules for storing data in the non-volatile memory device. In some examples, aspects of the operations of 520 may be performed by a second FTL module 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a first flash translation layer (FTL) module coupled with a first I/O interface, first data from the first I/O interface in accordance with a first set of communication rules for communicating over the I/O interface; preparing, by the first FTL module, the first data for storage in the non-volatile memory device in accordance with a first set of storage rules for storing data in the non-volatile memory device; receiving, at a second FTL module coupled with a second I/O interface, second data from the second I/O interface in accordance with a second set of communication rules for communicating over the second I/O interface; and preparing, by the second FTL module, the second data for storage in the non-volatile memory device in accordance with a second set of storage rules for storing data in the non-volatile memory device.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 2: A memory system, including: a first flash translation layer (FTL) module coupled with a first I/O interface, the first FTL module configured to: receive first data from the first I/O interface in accordance with a first set of communication rules for communicating over the I/O interface, and prepare the first data for storage in a non-volatile memory device in accordance with a first set of storage rules for storing data in the non-volatile memory device; and a second FTL module coupled with a second I/O interface, the second FTL module configured to: receive second data from the second I/O interface in accordance with a second set of communication rules for communicating over the second I/O interface, and prepare the second data for storage in the non-volatile memory device in accordance with a second set of storage rules for storing data in the non-volatile memory device.

Aspect 3: The memory system of aspect 2, where the first I/O interface is configured to transmit third data in accordance with the first set of communication rules, and the second I/O interface is configured to transmit fourth data in accordance with the second set of communication rules.

Aspect 4: The memory system of any of aspects 2 through 3, where the first set of communication rules permits receipt of the first data in a sequential manner or a random manner, and the second set of communication rules permits receipt of the second data in exclusively a sequential manner.

Aspect 5: The memory system of any of aspects 2 through 4, where the first set of communication rules permits a size of the first data to be within a first range of sizes, and the second set of communication rules permits a size of the second data to be within a second range of sizes.

Aspect 6: The memory system of any of aspects 2 through 5, where the first set of storage rules permits storage of the first data in a sequential manner or a random manner, and the second set of storage rules permits storage of the second data in exclusively a sequential manner.

Aspect 7: The memory system of any of aspects 2 through 6, where the first set of storage rules permits a storage size for the first data to be within a first range of sizes, and the second set of storage rules permits a storage size for the second data to be within a second range of sizes.

Aspect 8: The memory system of any of aspects 2 through 7, where the first I/O interface is coupled with a processor, and the second I/O interface is coupled with a sensor.

Aspect 9: The memory system of any of aspects 2 through 8, where the memory system is included in a vehicle, the first FTL module is configured to receive driving assistance data, including the first data, for the vehicle over the first I/O interface, and the second FTL module is configured to receive sensor data, including the second data, for the vehicle over the second I/O interface.

Aspect 10: The memory system of any of aspects 2 through 9, where the memory system is included in a vehicle, the first FTL module is configured to receive in-vehicle media data, including the first data, for the vehicle over the first I/O interface, and the second FTL module is configured to receive sensor data, including the second data, for the vehicle over the second I/O interface.

Aspect 11: The memory system of any of aspects 2 through 10, where the first FTL module and the second FTL module are each coupled with a same backend circuitry that is configured to communicate with the non-volatile memory device.

Aspect 12: The memory system of any of aspects 2 through 11, where the first I/O interface is coupled with a first processor, and where the second I/O interface is coupled with a sensor, the memory system further including: a second I/O interface coupled with the first FTL module and a second processor and configured to communicate data in accordance with the first set of communication rules.

Aspect 13: The memory system of any of aspects 2 through 12, where the first I/O interface is coupled with a first processor, and where the second I/O interface is coupled with a sensor, the memory system further including: a second I/O interface coupled with the second FTL module and a second sensor and configured to communicate data in accordance with the second set of communication rules.

An apparatus is described. The following provides an overview of aspects of the apparatus as described herein:

Aspect 14: A memory system, including: a non-volatile memory device; a first I/O interface coupled with a processor of a vehicle and configured to receive first data from the processor in accordance with a first set of communication rules; a second I/O interface coupled with a sensor of the vehicle and configured to receive second data from the sensor in accordance with a second set of communication rules; a first flash translation layer (FTL) module coupled with the first I/O interface and configured to prepare the first data from the first I/O interface for storage in the non-volatile memory device in accordance with a first set of storage rules for storing data in the non-volatile memory device; and a second FTL module coupled with the second I/O interface and configured to prepare the second data from the second I/O interface for storage in the non-volatile memory device in accordance with a second set of storage rules for storing data in the non-volatile memory device.

Aspect 15: The memory system of aspect 14, where the first I/O interface is configured to transmit third data in accordance with the first set of communication rules to the processor, and the second I/O interface is configured to transmit fourth data in accordance with the second set of communication rules to the sensor.

Aspect 16: The memory system of any of aspects 14 through 15, where the first set of communication rules permits receipt of the first data in a sequential manner or a random manner, and the second set of communication rules permits receipt of the second data in exclusively a sequential manner.

Aspect 17: The memory system of any of aspects 14 through 16, where the first set of communication rules permits a size of the first data to be within a first range of sizes, and the second set of communication rules permits a size of the second data to be within a second range of sizes.

Aspect 18: The memory system of any of aspects 14 through 17, where the first set of storage rules permits storage of the first data in a sequential manner or a random manner, and the second set of storage rules permits storage of the second data in exclusively a sequential manner.

Aspect 19: The memory system of any of aspects 14 through 18, where the first set of storage rules permits a storage size for the first data to be within a first range of sizes, and the second set of storage rules permits a storage size for the second data to be within a second range of sizes.

Aspect 20: The memory system of any of aspects 14 through 19, where the first data includes driving assistance data for the vehicle, and the second data includes environmental data for the vehicle sensed by the sensor.

Aspect 21: The memory system of any of aspects 14 through 20, where the first data includes in-vehicle media data, and the second data includes environmental data for the vehicle sensed by the sensor.

Aspect 22: The memory system of any of aspects 14 through 21, where the first FTL module and the second FTL module are each coupled with a same backend circuitry that is configured to communicate with the non-volatile memory device.

Aspect 23: The memory system of any of aspects 14 through 22, further including: a second I/O interface coupled with the first FTL module and a second processor and configured to communicate data in accordance with the first set of communication rules.

Aspect 24: The memory system of any of aspects 14 through 23, further including: a second I/O interface coupled with the second FTL module and a second sensor and configured to communicate data in accordance with the second set of communication rules.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off”' or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A memory system, comprising:
a first flash translation layer (FTL) module coupled with a first input/output (I/O) interface, the first FTL module configured to:
receive first data from the first I/O interface in accordance with a first set of communication rules for communicating over the first I/O interface, and
prepare the first data for storage in a non-volatile memory device in accordance with a first set of storage rules for storing data in the non-volatile memory device; and
a second FTL module coupled with a second I/O interface, the second FTL module configured to:
receive second data from the second I/O interface in accordance with a second set of communication rules for communicating over the second I/O interface, and
prepare the second data for storage in the non-volatile memory device in accordance with a second set of storage rules for storing data in the non-volatile memory device.

2. The memory system of claim 1, wherein the first I/O interface is configured to transmit third data in accordance with the first set of communication rules, and wherein the second I/O interface is configured to transmit fourth data in accordance with the second set of communication rules.

3. The memory system of claim 1, wherein the first set of communication rules permits receipt of the first data in a sequential manner or a random manner, and wherein the second set of communication rules permits receipt of the second data in exclusively a sequential manner.

4. The memory system of claim 1, wherein the first set of communication rules permits a size of the first data to be within a first range of sizes, and wherein the second set of communication rules permits a size of the second data to be within a second range of sizes.

5. The memory system of claim 1, wherein the first set of storage rules permits storage of the first data in a sequential manner or a random manner, and wherein the second set of storage rules permits storage of the second data in exclusively a sequential manner.

6. The memory system of claim 1, wherein the first set of storage rules permits a storage size for the first data to be within a first range of sizes, and wherein the second set of storage rules permits a storage size for the second data to be within a second range of sizes.

7. The memory system of claim 1, wherein the first I/O interface is coupled with a processor, and wherein the second I/O interface is coupled with a sensor.

8. The memory system of claim 1, wherein the memory system is included in a vehicle, wherein the first FTL module is configured to receive driving assistance data, including the first data, for the vehicle over the first I/O interface, and wherein the second FTL module is configured to receive sensor data, including the second data, for the vehicle over the second I/O interface.

9. The memory system of claim 1, wherein the memory system is included in a vehicle, the first FTL module is configured to receive in-vehicle media data, including the first data, for the vehicle over the first I/O interface, and wherein the second FTL module is configured to receive sensor data, including the second data, for the vehicle over the second I/O interface.

10. The memory system of claim 1, wherein the first FTL module and the second FTL module are each coupled with a same backend circuitry that is configured to communicate with the non-volatile memory device.

11. The memory system of claim 1, wherein the first I/O interface is coupled with a first processor, and wherein the second I/O interface is coupled with a sensor, the memory system further comprising:
a second I/O interface coupled with the first FTL module and a second processor and configured to communicate data in accordance with the first set of communication rules.

12. The memory system of claim 1, wherein the first I/O interface is coupled with a first processor, and wherein the second I/O interface is coupled with a sensor, the memory system further comprising:
a second I/O interface coupled with the second FTL module and a second sensor and configured to communicate data in accordance with the second set of communication rules.

13. A memory system, comprising:
a non-volatile memory device;
a first input/output (I/O) interface coupled with a processor of a vehicle and configured to receive first data from the processor in accordance with a first set of communication rules;
a second I/O interface coupled with a sensor of the vehicle and configured to receive second data from the sensor in accordance with a second set of communication rules;
a first flash translation layer (FTL) module coupled with the first I/O interface and configured to prepare the first data from the first I/O interface for storage in the non-volatile memory device in accordance with a first set of storage rules for storing data in the non-volatile memory device; and
a second FTL module coupled with the second I/O interface and configured to prepare the second data from the second I/O interface for storage in the non-volatile memory device in accordance with a second set of storage rules for storing data in the non-volatile memory device.

14. The memory system of claim 13, wherein the first I/O interface is configured to transmit third data in accordance with the first set of communication rules to the processor, and wherein the second I/O interface is configured to transmit fourth data in accordance with the second set of communication rules to the sensor.

15. The memory system of claim 13, wherein the first set of communication rules permits receipt of the first data in a sequential manner or a random manner, and wherein the second set of communication rules permits receipt of the second data in exclusively a sequential manner.

16. The memory system of claim 13, wherein the first set of communication rules permits a size of the first data to be within a first range of sizes, and wherein the second set of communication rules permits a size of the second data to be within a second range of sizes.

17. The memory system of claim 13, wherein the first set of storage rules permits storage of the first data in a sequential manner or a random manner, and wherein the second set of storage rules permits storage of the second data in exclusively a sequential manner.

18. The memory system of claim 13, wherein the first set of storage rules permits a storage size for the first data to be within a first range of sizes, and wherein the second set of storage rules permits a storage size for the second data to be within a second range of sizes.

19. The memory system of claim 13, wherein the first data comprises driving assistance data for the vehicle, and wherein the second data comprises environmental data for the vehicle sensed by the sensor.

20. The memory system of claim 13, wherein the first data comprises in-vehicle media data, and wherein the second data comprises environmental data for the vehicle sensed by the sensor.

21. The memory system of claim 13, wherein the first FTL module and the second FTL module are each coupled with a same backend circuitry that is configured to communicate with the non-volatile memory device.

22. The memory system of claim 13, further comprising:
a second I/O interface coupled with the first FTL module and a second processor and configured to communicate data in accordance with the first set of communication rules.

23. The memory system of claim 13, further comprising:
a second I/O interface coupled with the second FTL module and a second sensor and configured to communicate data in accordance with the second set of communication rules.

24. A method at a memory system comprising a non-volatile memory device, the method comprising:
receiving, at a first flash translation layer (FTL) module coupled with a first input/output (I/O) interface, first data from the first I/O interface in accordance with a first set of communication rules for communicating over the first I/O interface;
preparing, by the first FTL module, the first data for storage in the non-volatile memory device in accordance with a first set of storage rules for storing data in the non-volatile memory device;
receiving, at a second FTL module coupled with a second I/O interface, second data from the second I/O interface in accordance with a second set of communication rules for communicating over the second I/O interface; and
preparing, by the second FTL module, the second data for storage in the non-volatile memory device in accordance with a second set of storage rules for storing data in the non-volatile memory device.
